(19) United States
(12) Patent Application Publication
(10) Pub. No.: US 2022/0277117 A1
(43) Pub. Date: Sep. 1, 2022

(54) RESIN BEHAVIOR ANALYSIS APPARATUS, RESIN BEHAVIOR ANALYSIS METHOD AND RESIN BEHAVIOR ANALYSIS PROGRAM

(71) Applicant: Honda Motor Co., Ltd., Tokyo (JP)

(72) Inventors: Masatoshi Kobayashi, Wako-shi, Saitama (JP); Takuya Yamamoto, Chiyoda-ku, Tokyo (JP); Tatsuo Sakakibara, Chiyoda-ku, Tokyo (JP); Daisuke Urakami, Chuo-ku, Tokyo (JP); Akira Hyakusai, Shiga (JP)

(73) Assignee: Honda Motor Co., Ltd., Tokyo (JP)

(21) Appl. No.: 17/620,443

(22) PCT Filed: Jun. 18, 2020
(86) PCT No.: PCT/JP2020/023945

§ 371 Date: Dec. 17, 2021

(30) Foreign Application Priority Data
Jul. 2, 2019 (JP) 2019-123545

(51) Int. Cl. G06F 30/23; B29C 70/54

(52) U.S. Cl. CPC G06F 30/23; B29C 70/54; G06F 2113/24

(57) ABSTRACT

A resin behavior analysis apparatus configured to analyze behavior of a fiber when molding a sheet material of a fiber reinforced resin including a fiber bundle which is an assembly of a plurality of the fibers. The apparatus includes: a CPU and a memory connected to the CPU. The CPU is configured to perform: generating a sheet model which is a model of the sheet material; generating a fiber bundle model which is a model of the fiber bundle in the sheet model; generating a fiber model which is a model of the fiber in the fiber bundle model; and analyzing behavior of the fiber model based on a condition for molding the sheet material.

### CROSS-REFERENCE TO RELATED APPLICATION

This application is a National Stage of PCT international application Ser. No. PCT/JP2020/023945 filed on Jun. 18, 2020 which designates the United States, incorporated herein by reference, and which is based upon and claims the benefit of priority from Japanese Patent Application No. 2019-123545, filed on Jul. 2, 2019, the entire contents of which are incorporated herein by reference.

### TECHNICAL FIELD

This invention relates to a resin behavior analysis apparatus, a resin behavior analysis method and a resin behavior analysis program configured to analyze behavior of fiber when molding fiber reinforced resin.

### BACKGROUND ART

Conventionally, there has been known an apparatus configured to analyze behavior of a plurality of fibers flowing in a resin during molding when a sheet-shaped fiber reinforced resin is molded in a mold by pressure molding or the like to obtain a product having a desired shape (see, for example, Patent Document 1). In the apparatus described in Patent Document 1, a fiber model is configured by a plurality of nodes and beam elements connecting the nodes to each other, and a simulation using the fiber model is performed according to molding conditions to analyze the behavior of the fiber in flow.

### CITATION LIST

### Patent Literature

Patent Document 1: Japanese Patent No. 6203787

### DISCLOSURE OF INVENTION

### Problems to be Solved by the Invention

Incidentally, a sheet material of a general fiber reinforced resin is configured by assembling a plurality of fiber bundles using a fiber bundle in which a plurality of fibers are bonded as a constituent element. Therefore, it is preferable to perform behavior analysis of the fiber in consideration of the fiber bundle. However, since the apparatus described in Patent Document 1 does not consider the fiber bundle, it is difficult to accurately analyze the behavior of the fiber in the sheet.

### Means for Solving Problem

An aspect of the present invention is a resin behavior analysis apparatus configured to analyze behavior of a fiber when molding a sheet material of a fiber reinforced resin including a fiber bundle which is an assembly of a plurality of the fiber. The resin behavior analysis apparatus includes: a sheet model generation unit configured to generate a sheet model which is a model of the sheet material; a fiber bundle model generation unit configured to generate a fiber bundle model which is a model of the fiber bundle in the sheet model generated by the sheet model generation unit; a fiber model generation unit configured to generate a fiber model which is a model of the fiber in the fiber bundle model generated by the fiber bundle model generation unit; and a behavior analysis unit configured to analyze behavior of the fiber model generated by the fiber model generation unit based on a condition for molding the sheet material.

Another aspect of the present invention is a resin behavior analysis method configured to analyze behavior of a fiber when molding a sheet material of a fiber reinforced resin including a fiber bundle which is an assembly of a plurality of the fiber, by a computer. The computer is configured to execute steps of: generating a sheet model which is a model of the sheet material; generating a fiber bundle model which is a model of the fiber bundle in the sheet model generated; generating a fiber model which is a model of the fiber in the fiber bundle model generated; and analyzing behavior of the fiber model generated, based on a condition for molding the sheet material.

Further aspect of the present invention is a resin behavior analysis program configured to cause a computer analyze behavior of a fiber when molding a sheet material of a fiber reinforced resin including a fiber bundle which is an assembly of a plurality of the fiber. The computer is caused to execute: a sheet model generation step to generate a sheet model which is a model of the sheet material; a fiber bundle model generation step to generate a fiber bundle model which is a model of the fiber bundle in the sheet model generated in the sheet model generation step; a fiber model generation step to generate a fiber model which is a model of the fiber in the fiber bundle model generated in the fiber bundle model generation step; and a behavior analysis step to analyze behavior of the fiber model generated in the fiber model generation step based on a condition for molding the sheet material.

### Effect of the Invention

According to the present invention, it becomes possible to accurately analyze behavior of fibers contained in a sheet material of the fiber reinforced resin.

### BRIEF DESCRIPTION OF DRAWINGS

FIG. 1A is a cross-sectional view schematically illustrating an example of a molding step when a product is manufactured by molding a sheet material of a fiber reinforced resin in which a resin behavior analysis apparatus according to an embodiment of the present invention is applied.

FIG. 1B is a cross-sectional view schematically illustrating an example of the molding step, following FIG. 1A.

FIG. 1C is a cross-sectional view schematically illustrating an example of the molding step, following FIG. 1B.

FIG. 2A is a perspective view schematically illustrating an example of fibers mixed in an actual sheet material.

FIG. 2B is a perspective view schematically illustrating another example of the fibers mixed in the actual sheet material.

FIG. 3 is a cross-sectional view schematically illustrating the fibers in the sheet material by enlarging a part of the actual sheet material.

FIG. 4 is an enlarged cross-sectional view schematically illustrating a part of a conventional sheet model.

FIG. 5 is an enlarged cross-sectional view schematically illustrating a part of a sheet model used in the resin behavior analysis apparatus according to the embodiment of the present invention.

FIG. 6 is a block diagram illustrating a configuration of a main part of the resin behavior analysis apparatus according to the embodiment of the present invention.

FIG. 7 is a perspective view schematically illustrating an example of the sheet model generated by a sheet model generation unit shown in FIG. 6.

FIG. 8A is a perspective view schematically illustrating an example of a fiber bundle model generated by a fiber bundle model generation unit shown in FIG. 6.

FIG. 8B is a perspective view schematically illustrating another example of the fiber bundle model generated by the fiber bundle model generation unit shown in FIG. 6.

FIG. 9 is a plan view schematically illustrating an example of the fiber bundle model generated in the sheet model shown in FIG. 7.

FIG. 10A is a diagram illustrating an example of yaw angle distribution of the fiber bundle model shown in FIG. 9.

FIG. 10B is a diagram illustrating an example of pitch angle distribution of the fiber bundle model shown in FIG. 9.

FIG. 10C is a diagram illustrating an example of roll angle distribution of the fiber bundle model shown in FIG. 9.

FIG. 11A is a diagram for describing interference between the fiber bundle models generated in the sheet model shown in FIG. 9.

FIG. 11B is a diagram for describing an actual stacking state of the fiber bundles in the sheet material.

FIG. 12 is a plan view schematically illustrating an example of the fiber bundle model generated in the sheet model, similarly to FIG. 9.

FIG. 13 is a view of the fiber bundle model 5M of FIG. 12 as viewed from a direction orthogonal to the z axis.

FIG. 14 is a diagram for describing a state of stacking of the fiber bundle models in the sheet model.

FIG. 15 is a perspective view illustrating an example of the fiber model generated by a fiber model generation unit shown in FIG. 6.

FIG. 16 is a diagram for describing number of the fiber models generated in each fiber bundle model shown in FIG. 8A and FIG. 8B.

FIG. 17A is a perspective view illustrating an example of a cut sheet model.

FIG. 17B is a perspective view illustrating an example of a stacked sheet model.

FIG. 18 is a perspective view illustrating an example of a product model after behavior analysis by a behavior analysis unit shown in FIG. 6.

FIG. 19A is a drawing for describing additional generation of a virtual fiber bundle model and a virtual fiber model by the fiber bundle model generation unit and the fiber model generation unit shown in FIG. 6.

FIG. 19B is a drawing for describing additional generation of the virtual fiber model by the fiber model generation unit shown in FIG. 6.

FIG. 20A is a diagram for describing an example of modification of the additional generation of the virtual fiber model shown in FIGS. 19A, 19B.

FIG. 20B is a diagram for describing another example of modification of the additional generation of the virtual fiber model shown in FIGS. 19A, 19B.

FIG. 21 is a cross-sectional view schematically illustrating a microelement in the product model after the behavior analysis.

FIG. 22 is a flowchart illustrating an example of processing executed by the resin behavior analysis apparatus according to the embodiment of the present invention.

### DESCRIPTION OF EMBODIMENT

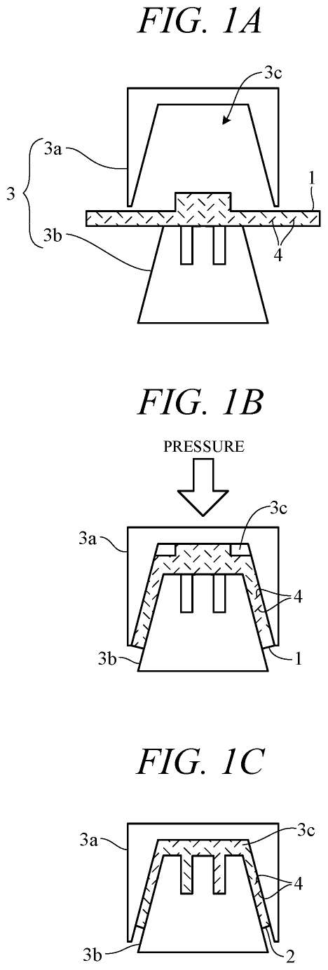

Hereinafter, an embodiment of the present invention will be described with reference to FIGS. 1A to 22. A resin behavior analysis apparatus according to an embodiment of the present invention is a computer aided engineering (CAE) analysis apparatus that performs preliminary examination of product design or the like by an analysis method such as a finite difference method, a finite element method, or a finite volume method using a computer, and is particularly an apparatus that analyzes behavior of a fiber reinforced resin when a sheet material of the fiber reinforced resin is molded to manufacture a product.

FIGS. 1A to 1C are cross-sectional views schematically illustrating an example of a molding step when a product (prototype product) 2 is manufactured by molding a sheet material 1 of a fiber reinforced resin in which the resin behavior analysis apparatus according to the embodiment of the present invention is applied. The example of FIGS. 1A to 1C illustrates the molding step when the sheet material 1 is pressurized to be molded using a mold 3 having a substantially quadrangular frustum shape including an upper mold 3a and a lower mold 3b. The sheet material 1 is made of a sheet-shaped resin mixed with fibers 4 such as carbon fibers and glass fibers. The fibers 4 mixed in the sheet material 1 are configured of discontinuous fibers (discontinuous fiber) as illustrated in FIGS. 1A to 1C or fibers (continuous fiber) which are continuous from one end to the other end of the sheet.

In the molding step using the mold 3, first, as illustrated in FIG. 1A, the sheet material 1 is placed on the lower mold 3b, and then, as illustrated in FIG. 1B, the upper mold 3a is lowered under a predetermined molding condition to pressurize the sheet material 1. As a result, the resin of the sheet material 1 flows in a cavity 3c of the mold 3, and is molded as the product 2 having a certain shape (a hollow substantially quadrangular frustum shape and a hat shape in FIG. 1C) as illustrated in FIG. 1C. In the product 2 obtained by such molding, product performance such as rigidity and strength is evaluated by a performance test, design, molding conditions, or the like are reviewed until a target value is achieved, and trial production and performance test are repeated. By replacing such trial production and performance test with CAE analysis, it is possible to evaluate product performance without actually trial producing the metal mold 3 and the product 2.

In general, in the process of molding the sheet material 1, when the resin of the sheet material 1 flows, the orientation, distribution, bending (waviness) state, or the like of the fibers 4 mixed in the resin change, whereby the product performance, such as rigidity and strength, of the product 2 changes. Therefore, in the CAE analysis, it is important to accurately analyze the flow behavior of the fibers 4 contained in the sheet material 1. In order to improve the accuracy of such behavior analysis, it is preferable to improve the accuracy of the model used for analysis, that is, to use a model closer to an actual production. In this respect, as a model of the cavity 3c portion of the mold 3, computer-aided design (CAD) design data of the mold 3 can be used. On the other hand, in the fiber 4 mixed in the sheet material 1, there is a problem that an arithmetic load at the time of behavior analysis becomes enormous when modeling is performed with the number and shape close to the actual production.

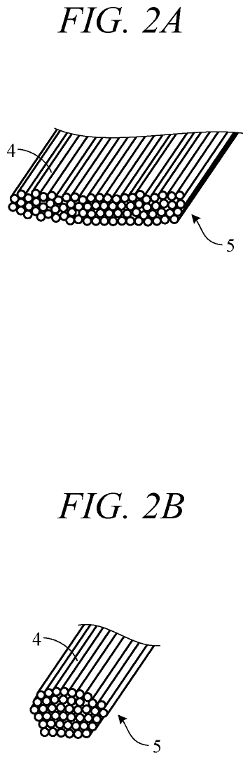

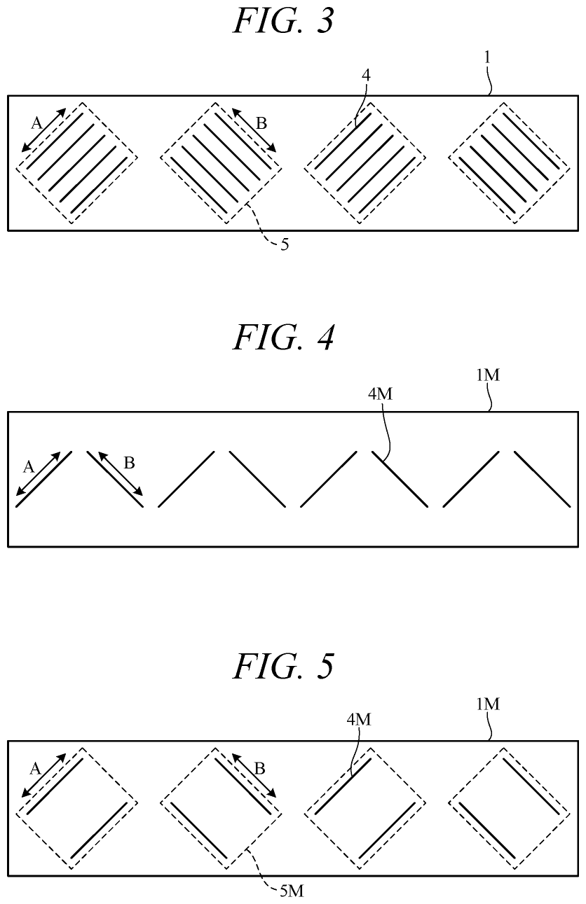

FIGS. 2A and 2B are perspective views schematically illustrating an example of the fibers 4 mixed in the actual sheet material 1, and FIG. 3 is a cross-sectional view schematically illustrating the fibers 4 in the sheet material 1 by enlarging a part of the actual sheet material 1. Further, FIG. 4 is an enlarged cross-sectional view schematically illustrating a part of a conventional sheet model, and FIG. 5 is an enlarged cross-sectional view schematically illustrating a part of a sheet model used in the resin behavior analysis apparatus according to the embodiment of the present invention.

As illustrated in FIGS. 2A to 3, the actual fibers 4 are dispersed and mixed in the sheet material 1 as a fiber bundle 5 having a quadrangular column shape (FIG. 2A) or an elliptical column shape (FIG. 2B) in which a plurality of (actually several thousands) fibers 4 are assembled in a bundle shape as illustrated in FIG. 3. In the behavior analysis, when modeling is faithfully performed, an arithmetic load becomes enormous. Therefore, conventionally, the fiber bundle 5 is not considered, and as illustrated in FIG. 4, a sheet model 1M in which a significantly smaller number of fiber models 4M than the actual number are singly dispersed is used for the behavior analysis.

Incidentally, the orientation (orientation distribution) of each fiber model 4M in the sheet model 1M is set according to the actual orientation of each fiber 4 in the sheet material 1. For example, as illustrated in FIG. 3, when the sheet material 1 is modeled in which the fibers 4 in an A direction are 50% and the fibers 4 in a B direction are 50%, the orientation distribution of the fiber model 4M in the sheet model 1M is set such that the fiber model 4M in the A direction is 50% and the fiber model 4M in the B direction is 50% as illustrated in FIG. 4. That is, in the conventional sheet model 1M, the fiber bundle 5 is not considered, and the fiber model 4M is uniformly dispersed in the sheet model 1M. Thus, the actual distribution state of the fibers 4 in the sheet material 1 is not accurately reflected.

In this regard, in the present embodiment, as illustrated in FIG. 5, a resin behavior analysis apparatus is configured as follows such that the behavior of the fibers 4 contained in the sheet material 1 of the fiber reinforced resin can be accurately analyzed using the sheet model 1M that accurately reflects the actual distribution state of the fibers 4 in the sheet material 1 in consideration of the fiber bundle 5.

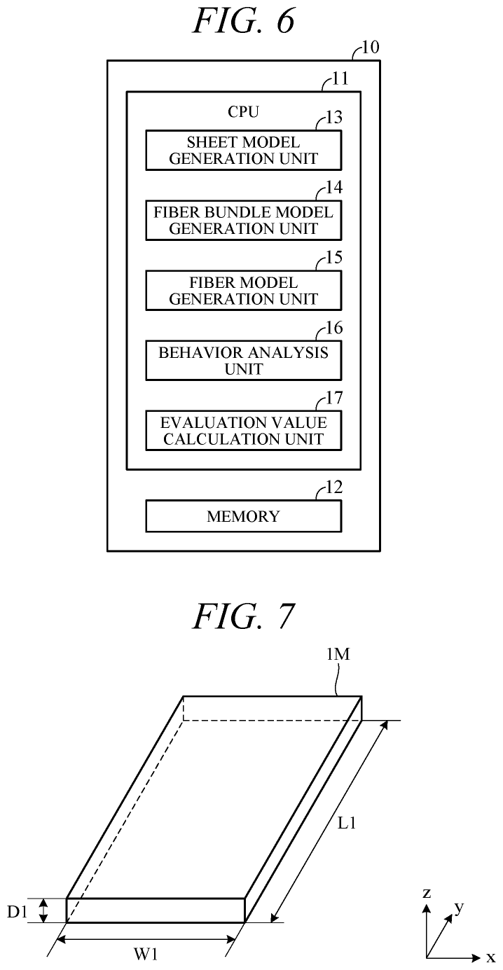

FIG. 6 is a block diagram illustrating a configuration of a main part of a resin behavior analysis apparatus (hereinafter, an apparatus) 10 according to the embodiment of the present invention. The apparatus 10 includes a computer including a CPU 11, a memory 12 such as a ROM and a RAM, other peripheral circuits such as an I/O interface, and the like. The CPU 11 functions as a sheet model generation unit 13 that generates a sheet model, a fiber bundle model generation unit 14 that generates a fiber bundle model in the sheet model, a fiber model generation unit 15 that generates a fiber model in the fiber bundle model, a behavior analysis unit 16 that analyzes behavior of the fiber model, and an evaluation value calculation unit 17 that evaluates a product model.

The memory 12 stores various setting values input via the I/O interface. As the various setting values, specific values may be set, but a plurality of values or ranges of values may be set, and screening may be automatically performed according to the analysis result.

The various setting values stored in the memory 12 include CAD design data of the mold 3, material characteristics of the mold 3, a shape of the sheet model 1M, a placement position of the sheet material 1 with respect to the mold 3, physical properties (viscosity, elastic modulus, thermal conductivity, or the like) of the resin of the sheet material 1, and the like. In addition, the shape (a total length, the number of divisions) of the fiber model 4M, the shape (a total length, a cross-sectional shape) of the fiber bundle model 5M, the orientation distribution of the fiber bundle models 5M in the sheet model 1M, the number and arrangement positions of the fiber models 4M in the fiber bundle model 5M, and the like are included. Further, molding conditions (a pressing force, a pressing speed, and the like in the case of pressure molding) and the like are included.

FIG. 7 is a perspective view schematically illustrating an example of the sheet model 1M generated by the sheet model generation unit 13. The sheet model generation unit 13 generates the sheet model 1M on the basis of the shape of the sheet model 1M stored in the memory 12. As illustrated in FIG. 7, the sheet model 1M is generated as a stereoscopic model defined by a width W1, a length L1, and a thickness D1. Hereinafter, the width direction of the sheet model 1M is defined as an x-axis direction, the length direction is defined as a y-axis direction, and the thickness direction is defined as a z-axis direction. The width W1, the length L1, and the thickness D1 of the sheet model 1M are set in advance on the basis of the actual shape of the sheet material 1.

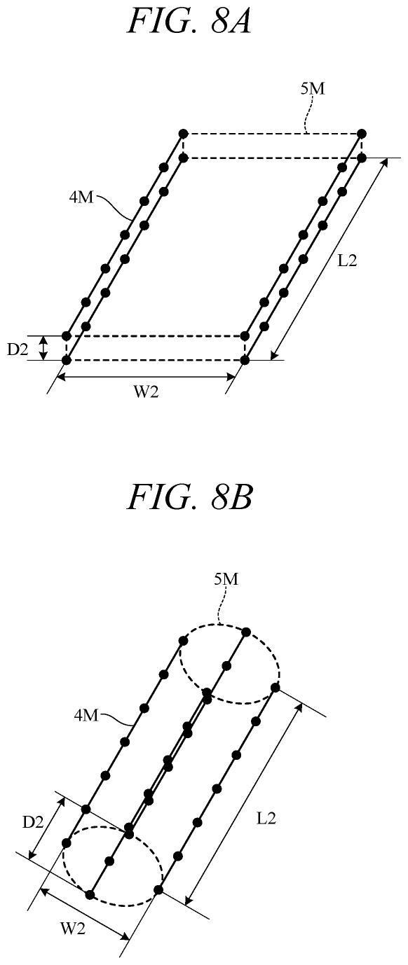

FIG. 8A is a perspective view schematically illustrating an example of the quadrangular columnar fiber bundle model 5M generated by the fiber bundle model generation unit 14, and FIG. 8B is a perspective view schematically illustrating an example of the elliptical columnar fiber bundle model 5M. The fiber bundle model generation unit 14 generates the fiber bundle model 5M on the basis of the shape (a total length and a cross-sectional shape) of the fiber bundle model 5M stored in the memory 12. As illustrated in FIGS. 8A and 8B, the fiber bundle model 5M is generated as a quadrangular columnar or elliptical columnar stereoscopic model defined by a width W2, a length L2, and a thickness D2. The width W2, the length L2, and the thickness D2 of the fiber bundle model 5M are set in advance on the basis of the actual shape (FIGS. 2A and 2B) of the fiber bundle 5.

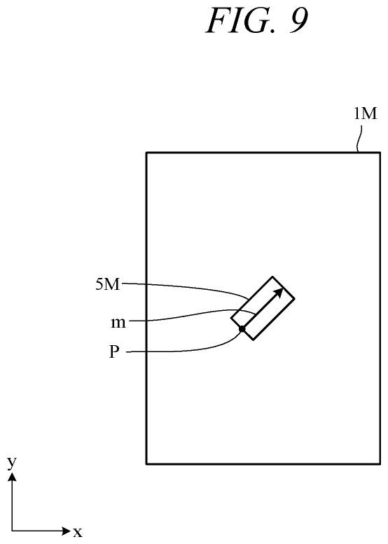

FIG. 9 is a plan view schematically illustrating an example of the fiber bundle model 5M (FIG. 8A) generated in the sheet model 1M, and schematically illustrating the sheet model 1M and the fiber bundle model 5M as viewed from the z-axis direction. As illustrated in FIG. 9, the sheet model generation unit 13 sequentially generates the fiber bundle model 5M in a direction m corresponding to the orientation distribution stored in the memory 12 at a random position P in the sheet model 1M.

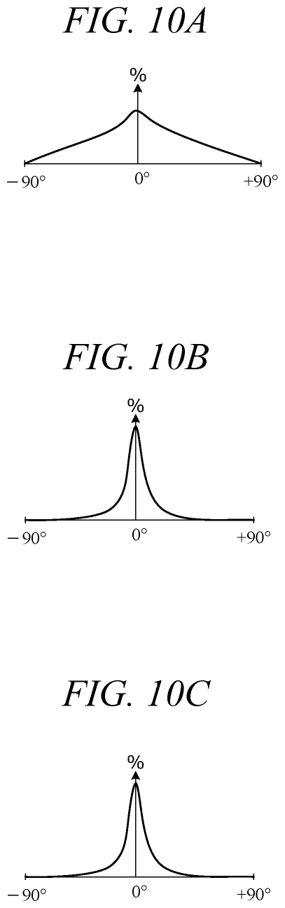

FIGS. 10A to 10C are diagrams illustrating an example of the orientation distribution of the fiber bundle model 5M, in which FIG. 10A illustrates a distribution of a yaw angle ψ around the z axis, FIG. 10B illustrates a distribution of a pitch angle θ around the x axis, and FIG. 10C illustrates a distribution of a roll angle φ around the y axis. The orientation distribution of the fiber bundle model 5M is set in advance on the basis of the orientation distribution of the fiber bundle 5 in the actual sheet material 1. The orientation distribution of the fiber bundle 5 in the actual sheet material 1 varies depending on the physical properties of the resin of the sheet material 1, the method for manufacturing the sheet material 1, and the like, and can be measured by an X-ray diffraction method or the like. Incidentally, the orientation distribution only for the yaw angle ψ may be set with the pitch angle θ and the roll angle φ as certain values.

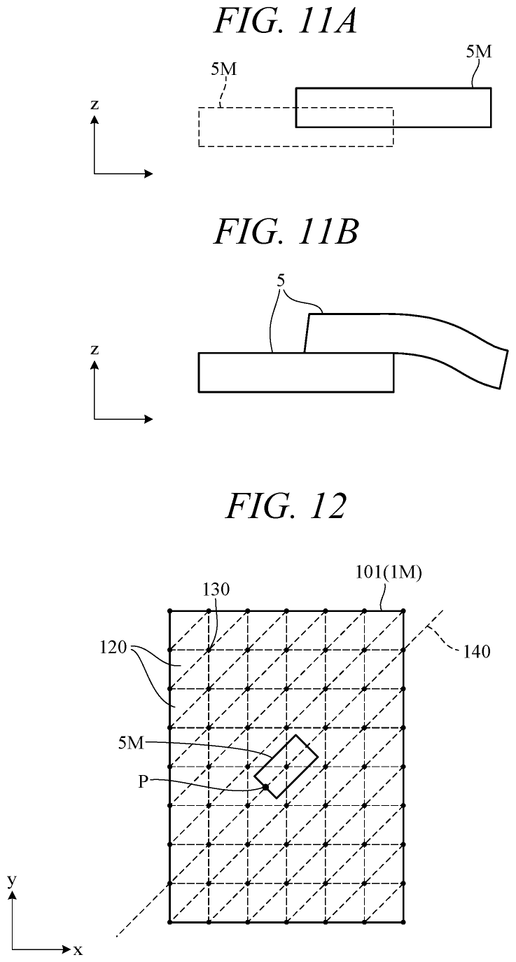

FIG. 11A is a diagram for describing interference between the fiber bundle models 5M generated in the sheet model 1M, and FIG. 11B is a diagram for describing an actual stacking state of the fiber bundles 5 in the sheet material 1. When the fiber bundle models 5M are sequentially generated at the random positions P in the sheet model 1M, as illustrated in FIG. 11A, a newly generated fiber bundle model 5M (indicated by a solid line) may interfere with (penetrate) the previously generated fiber bundle model 5M (indicated by a broken line). On the other hand, in the actual sheet material 1, as illustrated in FIG. 11B, the fiber bundles 5 are arranged to be stacked in the thickness direction (z-axis direction).

In order to arrange the fiber bundle models 5M with reflecting the stacking state of the fiber bundles 5, the fiber bundle model generation unit 14 sequentially stacks and arranges the generated fiber bundle models 5M (FIG. 9) in the z-axis direction. The arrangement of the fiber bundle model 5M by the fiber bundle model generation unit 14 will be specifically described with reference to FIGS. 12 to 14.

FIG. 12 is a plan view schematically illustrating the sheet model 1M and the fiber bundle model 5M when viewed from the z-axis direction, similarly to FIG. 9. As illustrated in FIG. 12, the fiber bundle model generation unit 14 generates a first fiber bundle model 5M at the random position P in the sheet model 1M, and equally divides the entire surface of a first layer 101 with the bottom surface of the sheet model 1M as the first layer 101 to generate a plurality of surfaces (faces) 120 such as triangles.

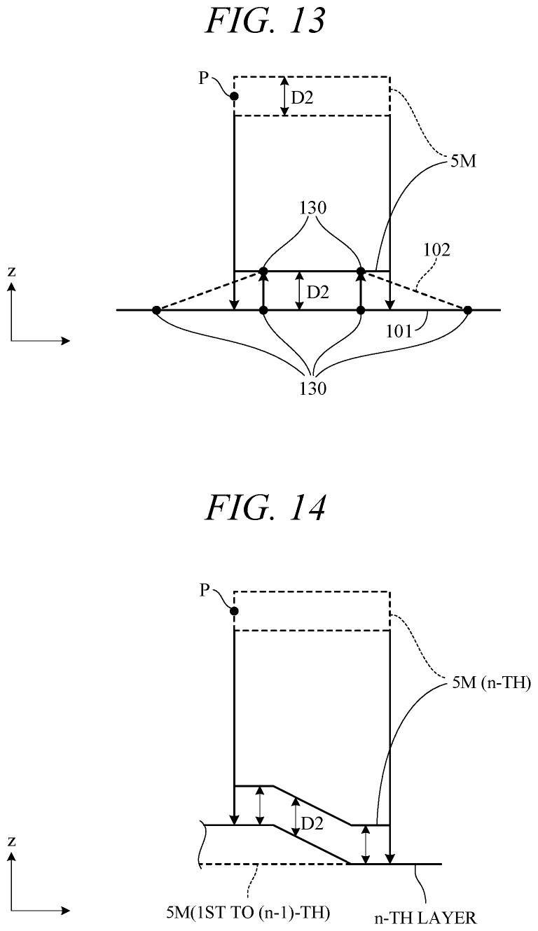

FIG. 13 is a view of the fiber bundle model 5M of FIG. 12 as viewed from a direction orthogonal to the z axis, and illustrates the fiber bundle model 5M as viewed from a direction orthogonal to an imaginary line 140 passing through an apex 130 (two apexes 130 in FIGS. 12 and 13) positioned below the fiber bundle model 5M of FIG. 12. As illustrated in FIG. 13, the fiber bundle model generation unit 14 projects the first fiber bundle model 5M generated at the random position P onto the first layer 101 along the z-axis direction, and determines the arrangement as the fiber bundle model 5M having the thickness D2.

The fiber bundle model generation unit 14 moves the apex 130 positioned below the fiber bundle model 5M to the upper surface of the fiber bundle model 5M along the z-axis direction by the thickness D2, and performs a smoothing process of the face 120 in response to the moved apex 130 to generate a second layer 102. That is, the second layer 102 and the subsequent layers are generated to avoid the previously generated and arranged fiber bundle model 5M. Thereafter, the fiber bundle model generation unit 14 sequentially generates a second fiber bundle models 5M, a third fiber bundle models 5M, and so on at the random positions P, and arranges the fiber bundle models 5M in the second layer 102, a third layer 103, and so on.

FIG. 14 is a diagram for describing a state of stacking of the fiber bundle models 5M in the sheet model 1M, and schematically illustrates the fiber bundle model 5M as viewed from a direction orthogonal to the z axis. As illustrated in FIG. 14, the fiber bundle model generation unit 14 projects an n-th generated fiber bundle model 5M onto an n-th layer along the z-axis direction, and determines the arrangement as the fiber bundle model 5M having the thickness D2. In this way, when the n-th fiber bundle model 5M is arranged in the n-th layer generated to avoid the first to (n−1)-th fiber bundle models 5M, the fiber bundle models 5M can be sequentially stacked and arranged in the z-axis direction without interfering with each other.

The fiber bundle model generation unit 14 repeats the generation and arrangement of the fiber bundle model 5M until an average value Dn of the thickness (a height in the z-axis direction) between the first layer 101 corresponding to the bottom surface of the sheet model 1M and the n-th layer reaches the preset thickness D1 of the sheet model 1M.

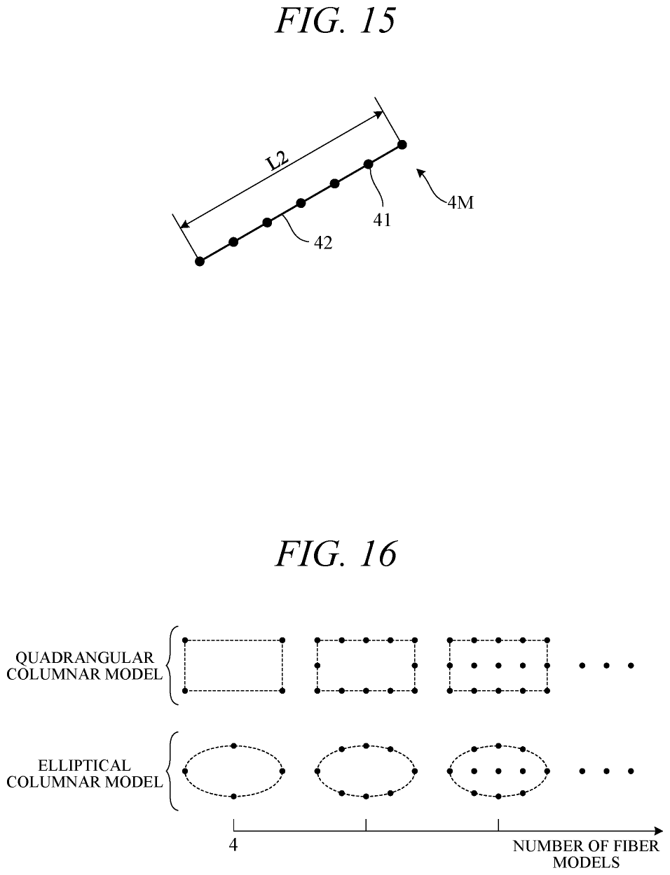

FIG. 15 is a perspective view illustrating an example of the fiber model 4M generated by the fiber model generation unit 15. The fiber model generation unit 15 generates the fiber model 4M in the fiber bundle model 5M on the basis of the shape of the fiber model 4M stored in the memory 12. As illustrated in FIG. 15, each fiber model 4M is defined by the total length L2 and the number of divisions (the number of divisions=6 in FIG. 15), and includes a plurality of (seven in FIG. 15) nodes 41 and beam elements 42 connecting the nodes 41 and corresponding to the number of divisions.

On the basis of the number and arrangement positions of the fiber models 4M in the fiber bundle model 5M stored in the memory 12, the fiber model generation unit 15 arranges the fiber models 4M in the fiber bundle model 5M which is generated by the fiber bundle model generation unit 14 and of which the arrangement in the sheet model 1M is determined. As a result, three-dimensional coordinates in the sheet model 1M are assigned to each node 41 of each fiber model 4M. In the behavior analysis, the behavior of the fiber model 4M is analyzed using the three-dimensional coordinates of each node 41.

As illustrated in FIGS. 8A and 8B, at least four fiber models 4M are arranged in each fiber bundle model 5M. As a result, the shape of each fiber bundle model 5M and the arrangement in the sheet model 1M are expressed by the three-dimensional coordinates of each node 41 of each fiber model 4M. That is, the actual distribution state of the fiber bundles 5 mixed in the sheet material 1 as schematically illustrated in FIG. 5 are reflected on the three-dimensional coordinates of the nodes 41.

FIG. 16 is a diagram for describing the number of the fiber models 4M generated in each fiber bundle model 5M. As illustrated in FIG. 16, four or more fiber models 4M can be arranged in each fiber bundle model 5M. When the number of fiber models 4M arranged in each fiber bundle model 5M is set to be larger, the number of nodes 41 used for behavior analysis increases, so that the analysis accuracy is improved, while an arithmetic load at the time of behavior analysis increases. Therefore, the number of fiber models 4M arranged in each fiber bundle model 5M is set according to various constraints such as the performance of the computer used for behavior analysis and the number of development steps of the product 2.

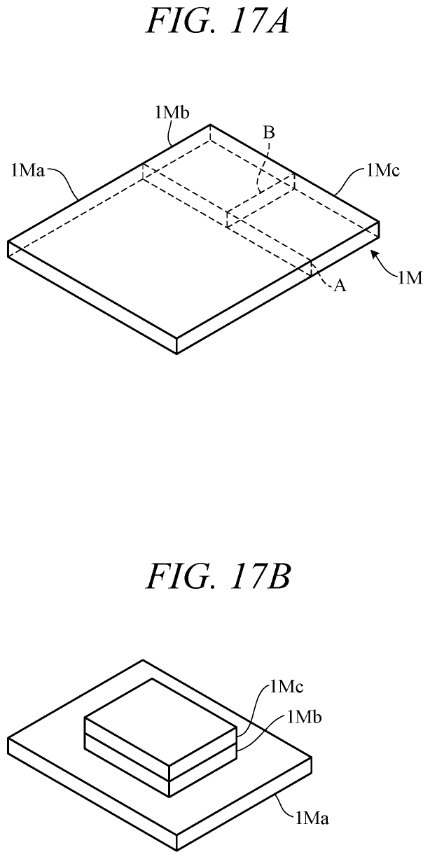

When the sheet model 1M, that is, the generation region of the fiber bundle model 5M is generated by the sheet model generation unit 13, the fiber bundle model 5M is generated and arranged by the fiber bundle model generation unit 14, and the fiber model 4M is generated by the fiber model generation unit 15, the sheet model 1M is completed. As illustrated in the example of FIG. 17A, the sheet model 1M completed in this manner can be divided into a plurality of (three in FIG. 17A) sheet models 1Ma to 1Mc by designating and cutting cut surfaces A and B. Further, as illustrated in FIG. 17B, the sheet models 1Ma to 1Mc can be stacked. Incidentally, the fiber bundle model 5M and the fiber model 4M intersecting the cut surfaces A and B may be cut at intersections with the cut surfaces A and B, may be extended outside the sheet model 1M without being cut, or may be deleted from the inside of the sheet model 1M.

The behavior analysis unit 16 performs behavior analysis using the fiber model 4M on the basis of the molding conditions or the like stored in the memory 12. That is, the behavior of the fiber 4 flowing in the resin of the sheet material 1 during molding is simulated using the three-dimensional coordinates of the node 41 of the fiber model 4M. Specifically, the behavior analysis unit 16 calculates a flow velocity distribution of the resin in a three-dimensional space for each unit time using a finite element method, an finite volume method, or the like on the basis of the CAD design data of the mold 3, the placement position of the sheet material 1 with respect to the mold 3 (FIG. 1A), the physical properties of the resin of the sheet material 1, and the molding conditions such as a pressing force and a pressing speed. Further, the behavior analysis unit 16 calculates the three-dimensional coordinates of each node 41 of each fiber model 4M flowing in the resin for each unit time on the basis of the calculated flow velocity distribution. Incidentally, in this simulation, the shape of the fiber bundle model 5M and the arrangement in the sheet model 1M are not used, and thus the fiber bundle model 5M itself is deleted before performing the simulation. By deleting the fiber bundle model 5M, an arithmetic load at the time of performing simulation can be reduced.

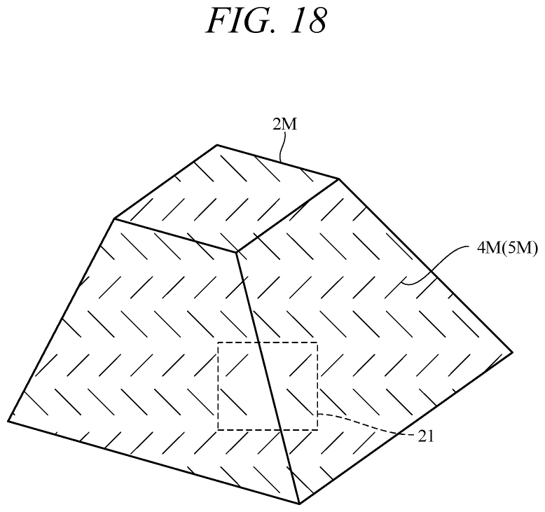

FIG. 18 is a perspective view illustrating an example of a product model 2M after the behavior analysis, and schematically illustrates the hat-shaped product model 2M corresponding to the product 2 in FIG. 1C. As illustrated in FIG. 18, when the behavior analysis by the behavior analysis unit 16 is completed, the product model 2M reflecting the orientation, distribution, bending (waviness) state, or the like of the fibers 4 (FIG. 1C) in the product 2 after molding is obtained. In the CAE analysis, the orientation, distribution, bending (waviness) state, or the like of the fiber model 4M in the product model 2M after the behavior analysis is evaluated to predict the product performance, such as rigidity and strength, of the product 2 and perform preliminary examination of product design. Therefore, the evaluation accuracy is improved when the number of fiber models 4M in the product model 2M after the behavior analysis is larger.

On the other hand, since the arithmetic load at the time of behavior analysis increases when the number of fiber models 4M increases, the number of fiber models 4M before the behavior analysis is set to be smaller than the actual number according to various constraints such as the performance of the computer used for behavior analysis and the number of development steps of the product 2. Therefore, as illustrated in the example of FIG. 18, a region 21 in which the existence ratio of the fiber model 4M is low may occur in the product model 2M after the behavior analysis. In order to ensure sufficient evaluation accuracy even in such the region 21, the fiber model 4M is additionally generated in the product model 2M after the behavior analysis.

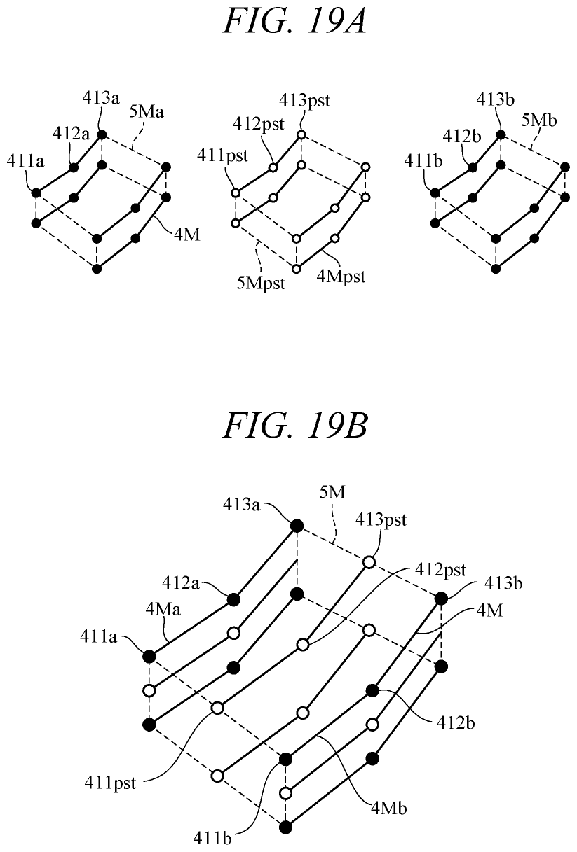

FIGS. 19A and 19B are diagrams for describing additional generation of a virtual fiber bundle model 5Mpst and a virtual fiber model 4Mpst by the fiber bundle model generation unit 14 and the fiber model generation unit 15, and schematically illustrate the fiber bundle model 5M and the fiber model 4M after the behavior analysis.

As illustrated in FIG. 19A, the fiber bundle model generation unit 14 additionally generates the virtual fiber bundle model 5Mpst on the basis of the three-dimensional coordinates of the nodes 41 of a pair of fiber bundle models 5Ma and 5Mb in the product model 2M (in particular, in the region 21). For example, three-dimensional coordinates of nodes 411pst, 412pst, 413pst, and so on of the virtual fiber bundle model 5Mpst are calculated as midpoints between the nodes 411a, 412a, 413a, and so on of one fiber bundle model 5Ma and the nodes 411b, 412b, 413b, and so on of the other fiber bundle model 5Mb. The virtual fiber bundle model 5Mpst additionally generated by the fiber bundle model generation unit 14 is not limited to the midpoint between the pair of fiber bundle models 5Ma and 5Mb, and may be an inner split point or an outer split point of an arbitrary ratio.

As illustrated in FIG. 19A, the fiber model generation unit 15 additionally generates the virtual fiber model 4Mpst having the same shape as the fiber model 4M in the virtual fiber bundle model 5Mpst additionally generated by the fiber bundle model generation unit 14. The virtual fiber model 4Mpst is additionally generated in the virtual fiber bundle model 5Mpst to have the same number and arrangement position as those of the fiber model 4M in the fiber bundle model 5M. As a result, the virtual fiber bundle model 5Mpst and the virtual fiber model 4Mpst are additionally generated in the product model 2M after the behavior analysis.

As illustrated in FIG. 19B, the fiber model generation unit 15 additionally generates the virtual fiber model 4Mpst on the basis of the three-dimensional coordinates of the nodes 41 of a pair of fiber models 4Ma and 4Mb in each fiber bundle model 5M. For example, the three-dimensional coordinates of the nodes 411pst, 412pst, 413pst, and so on of the virtual fiber model 4Mpst are calculated as midpoints between the nodes 411a, 412a, 413a, and so on of one fiber model 4Ma and the nodes 411b, 412b, 413b, and so on of the other fiber model 4Mb. The virtual fiber model 4Mpst additionally generated by the fiber model generation unit 15 is not limited to the midpoint between the pair of fiber models 4Ma and 4Mb, and may be an inner split point of an arbitrary ratio. Further, the virtual fiber model 4Mpst may be additionally generated in each virtual fiber bundle model 5Mpst. As a result, the virtual fiber model 4Mpst is additionally generated in the product model 2M after the behavior analysis.

The additional generation of the virtual fiber bundle model 5Mpst and the virtual fiber model 4Mpst by the fiber bundle model generation unit 14 and the fiber model generation unit 15 may be performed for the region 21 (FIG. 18) designated in the product model 2M after the behavior analysis or may be performed for the entire region in the product model 2M. In a case where the virtual fiber bundle model 5Mpst and the virtual fiber model 4Mpst are additionally generated in the designated region 21, the additional generation process is repeated until the existence ratio of the fiber model 4M and the virtual fiber model 4Mpst reaches a designated existence ratio, for example. In a case where the virtual fiber bundle model 5Mpst and the virtual fiber model 4Mpst are additionally generated in the entire region in the product model 2M, the additional generation process is repeated until the number of the fiber models 4M and the virtual fiber models 4Mpst reaches a designated number, for example.

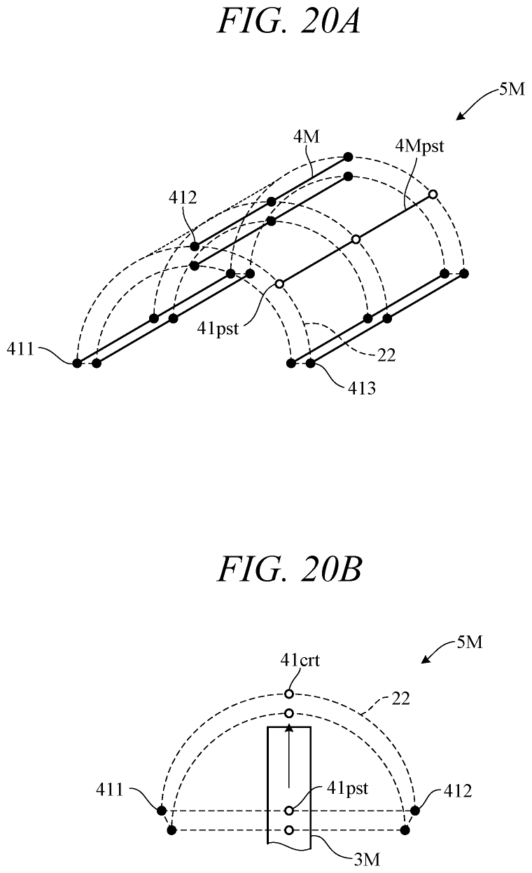

FIGS. 20A and 20B are diagrams for describing an example of modification of the additional generation of the virtual fiber model 4Mpst by the fiber model generation unit 15. FIG. 20A is a perspective view schematically illustrating the fiber bundle model 5M after the behavior analysis, and FIG. 20B is a cross-sectional view schematically illustrating the mold model 3M and the fiber bundle model 5M after the behavior analysis.

As illustrated in FIG. 20A, each virtual node 41pst of the virtual fiber model 4Mpst additionally generated by the fiber model generation unit 15 is not limited to a point on a straight line passing through a pair of nodes 412 and 413 of the fiber model 4M, and may be a point on a curve passing through the nodes 411 to 413. That is, the fiber model generation unit 15 determines the approximate expression of the curve corresponding to each side 22 of the fiber bundle model 5M on the basis of the three-dimensional coordinates of the node 411 to 413 and calculates the three-dimensional coordinates of the virtual node 41pst as a point (for example, the midpoint of the nodes 412 and 413) on the side 22. The curve corresponding to each side 22 can be approximated as an n-th degree polynomial, a circle, an ellipse, a sine curve, or the like, for example, by a least squares method or the like.

The fiber model generation unit 15 corrects the three-dimensional coordinates of the virtual node 41pst additionally generated in consideration of the shape data of the mold 3. As illustrated in FIG. 20B, in a case where the virtual node 41pst is additionally generated in the mold model 3M, the fiber model generation unit 15 determines the approximate expression of the curve corresponding to each side 22 of the fiber bundle model 5M on the basis of the shape data of the mold 3 and the three-dimensional coordinates of the nodes 411 and 412. Next, the virtual node 41pst is corrected as a point (for example, the midpoint of the nodes 411 and 412) 41crt on the side 22.

When each side 22 of the fiber bundle model 5M is formed as a curve in this manner, the virtual fiber model 4Mpst can be additionally generated at a position more accurately reflecting the shape of the fiber bundle 5 configured of several thousand fibers 4 and smoothly deformed. In addition, when the three-dimensional coordinates of the virtual node 41pst additionally generated are corrected in consideration of the shape data of the mold 3, it is possible to prevent the virtual fiber model 4Mpst from being additionally generated outside the mold space corresponding to the cavity 3c of the mold 3.

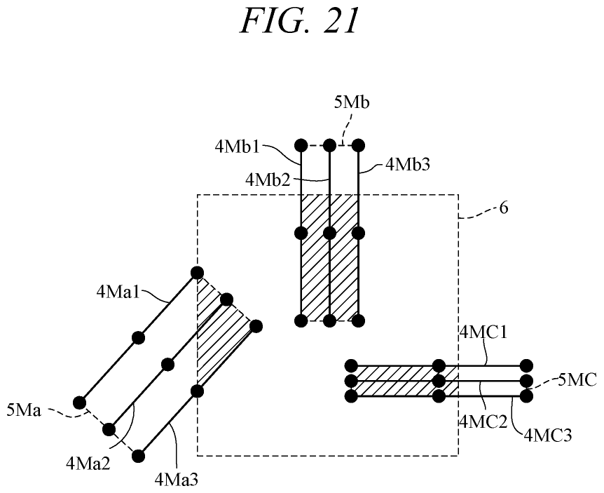

The evaluation value calculation unit 17 performs various evaluations of the product model 2M on the basis of the three-dimensional coordinates of the node 41 and the virtual nodes 41pst and 41crt after the behavior analysis. An example of various evaluation values calculated by the evaluation value calculation unit 17 will be briefly described with reference to FIG. 21.

The evaluation value calculation unit 17 calculates a local average fiber bundle volume ratio VEbdl and average fiber volume ratio VEf in the product model 2M. FIG. 21 is a cross-sectional view schematically illustrating a microelement 6 in the product model 2M after the behavior analysis. In the example of FIG. 21, the fiber bundle models 5Ma to 5Mc are included in the microelement 6. Here, the volume ratios of the fiber bundle models 5Ma to 5Mc in the microelement 6 are set to a to c, the volume of the microelement 6 is set to V, the volumes of the fiber bundle models 5Ma to 5Mc are respectively set to Va to Vc, the actual volume per fiber 4 is set to Vf, and the actual number of fibers 4 per fiber bundle 5 is set to N.

The evaluation value calculation unit 17 calculates the volume ratios (fiber volume ratios) VEfa to VEfc of the fibers 4 predicted for the fiber bundle models 5Ma to 5Mc, for example, the fiber volume ratio VEfa of the fiber bundle model 5Ma by the following formula (i).

VEfa=N×Vf/Va (i)

Incidentally, instead of the actual number N of the fibers 4 per fiber bundle 5, the numbers Na to Nc of the fiber models 4M in the fiber bundle models 5Ma to 5Mc may be used.

The evaluation value calculation unit 17 calculates the volume ratio (average fiber bundle volume ratio) VEbdl of the fiber bundle models 5Ma to 5Mc in the microelement 6 by the following formula (ii).

VEbd1=(a×Va+b×Vb+c×Vc)/V (ii)

The evaluation value calculation unit 17 further calculates the volume ratio (average fiber volume ratio) VEf of the fiber 4 predicted for the microelement 6 by the following formula (iii).

VEf=(a×Va×VEfa+b×Vb×VEfb+c×Vc×VEfc)/V (iii)

The evaluation value calculation unit 17 calculates an average orientation degree f of the fiber models 4M in the microelement 6. That is, as illustrated in FIG. 21, the average orientation degree f of the N fiber models 4Ma2 to 4Mc3 included in the microelements 6 can be calculated by the following formula (iv), where a is an angle formed by a reference direction and the extending direction of each fiber model 4M, and (cos α)\hat{ }2 is an average orientation coefficient.

f=(3(cos 2α)\hat{ }2−1)/2 (iv)

The evaluation value calculation unit 17 calculates an average fiber bending rate Af of the fiber models 4M in the microelement 6. That is, as illustrated in FIG. 21, the average fiber bending rate Af is calculated by the following equation (v), where the bending rates of the N fiber models 4Ma2 to 4Mc3 included in the microelements 6 are Afa2 to Afc3.

Af=(Afa2+Afa3+ . . . Afc2+Afc3+ . . . )/N (v)

Incidentally, instead of the bending rates Afa2 to Afc3 for the fiber models 4M, the bending rates of the portions of the fiber models 4M included in the microelements 6 may be used.

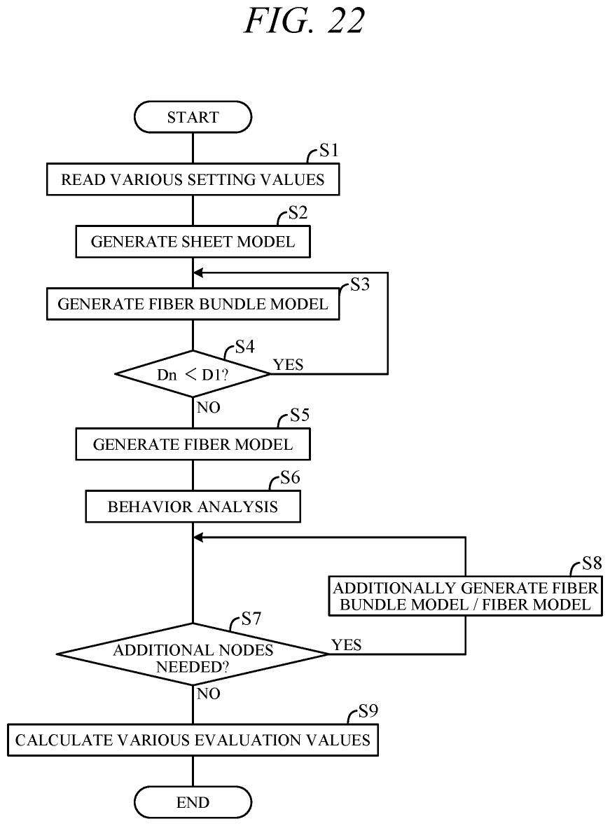

FIG. 22 is a flowchart illustrating an example of processing executed by the apparatus 10 according to a program stored in the memory in advance. The processing illustrated in the flowchart is executed when various setting values are input via the I/O interface.

First, in step S1, the various setting values stored in the memory 12 are read, and in step S2, the sheet model 1M (FIG. 7) which is a generation region of the fiber bundle model 5M is generated by processing in the sheet model generation unit 13. Next, in step S3, the fiber bundle model 5M (FIGS. 8A and 8B) is generated and arranged in the sheet model 1M generated in step S2 by processing in the fiber bundle model generation unit 14. Next, in step S4, it is determined whether or not the average value Dn of the thicknesses of the fiber bundle model 5M generated and arranged in step S3 is less than the preset thickness D1 of the sheet model 1M. When the determination in step S4 is positive, the process returns to step S3, and when the determination is negative, the process proceeds to step S5. In step S5, the fiber model 4M (FIG. 15) is generated in each fiber bundle model 5M generated and arranged in step S3 by the processing in the fiber model generation unit 15.

Next, in step S6, the behavior analysis is performed using the fiber model 4M generated in step S5 by the processing in the behavior analysis unit 16, and the product model 2M (FIG. 18) is generated. Next, in step S7, it is determined whether or not it is necessary to add the fiber bundle model 5M or the fiber model 4M. Incidentally, the determination process in step S7 may be performed in response to a command input by a user who visually checks the product model 2M displayed on a display of a computer or the like or may be automatically performed on the basis of a preset existence ratio of the fiber model 4M.

When the determination in step S7 is positive, the process proceeds to step S8, and the virtual fiber bundle model 5Mpst and the virtual fiber model 4Mpst (FIGS. 19A and 19B) are additionally generated by the processing in the fiber bundle model generation unit 14 and the fiber model generation unit 15. On the other hand, when the determination in step S7 is negative, the process proceeds to step S9, and various evaluation values are calculated by the processing in the evaluation value calculation unit 17.

Since the fiber model 4M is not directly arranged in the sheet model 1M but is arranged in the fiber bundle model 5M arranged in the sheet model 1M, it is possible to generate the sheet model 1M reflecting the distribution state of the fibers 4 mixed as the fiber bundle 5 in the actual sheet material 1 (steps S1 to S5 in FIG. 22). As a result, the accuracy of the behavior analysis of the fiber model 4M is improved (step S6), and the highly accurate product model 2M can be obtained, so that the evaluation accuracy of the product model 2M can be improved (step S9).

Since the fiber bundle model 5M and the fiber model 4M are additionally generated in the product model 2M after the behavior analysis as necessary (steps S7 and S8), the evaluation accuracy of the product model 2M can be improved without increasing the arithmetic load at the time of behavior analysis.

According to the embodiment of the present invention, the following advantageous effects can be obtained:

(1) The apparatus 10 is configured to analyze behavior of the fiber 4 when molding the sheet material 1 of the fiber reinforced resin including the fiber bundle 5 which is an assembly of a plurality of fibers 4. The apparatus 10 includes: the sheet model generation unit 13 configured to generate the sheet model 1M which is a model of the sheet material 1; the fiber bundle model generation unit 14 configured to generate the fiber bundle model 5M which is a model of the fiber bundle 5 in the sheet model 1M generated by the sheet model generation unit 13; the fiber model generation unit 15 configured to generate the fiber model 4M which is a model of the fiber 4 in the fiber bundle model 5M generated by the fiber bundle model generation unit 14; and the behavior analysis unit 16 configured to analyze behavior of the fiber model 4M generated by the fiber model generation unit 15 based on the condition for molding the sheet material 1 (FIG. 6).

When the fiber bundle model 5M is generated and arranged in the sheet model 1M, and the fiber model 4M is generated and arranged in the fiber bundle model 5M, it is possible to generate the highly accurate sheet model 1M reflecting the distribution state of the fibers 4 in the actual sheet material 1. As a result, the accuracy of the behavior analysis of the fiber model 4M and the evaluation accuracy of the product model 2M can be improved.

(2) The fiber bundle model 5M is a three-dimensional model surrounded by a plurality of surfaces including a plane or a curved surface (FIG. 8A, FIG. 8B). The fiber bundle model generation unit 14 generates the fiber bundle model 5M so as to extend in a columnar shape along the fiber direction in which the plurality of fibers 4 extend. The highly accurate fiber bundle model 5M can be easily generated by having a certain three-dimensional shape reflecting the shape of the actual fiber bundle 5 (FIGS. 2A and 2B).

(3) The fiber bundle model 5M has a square columnar shape extending along the fiber direction in which the plurality of fibers 4 extend (FIG. 8A). The fiber model generation unit 15 generates at least four fiber models 4M on the sides of the fiber bundle model 5M. Since the fiber bundle model 5M having a quadrangular prism shape reflecting the shape of the actual fiber bundle 5 (FIG. 2A) is defined by the limited number of fiber models 4M, the arithmetic load at the time of behavior analysis can be suppressed.

(4) The fiber bundle model 5M has a circular columnar shape extending along the fiber direction in which the plurality of fibers 4 extend (FIG. 8B). The fiber model generation unit 15 generates at least four fiber models 4M on the side surface of the fiber bundle model 5M. Since the elliptic prism-shaped fiber bundle model 5M reflecting the shape of the actual fiber bundle 5 (FIG. 2B) is defined by the limited number of fiber models 4M, the arithmetic load at the time of behavior analysis can be suppressed.

(5) The sheet model 1M is configured by including a plurality of fiber bundle models 5M extending in different directions from each other (FIG. 10A to FIG. 10C). When the orientation distribution of the fiber bundles 5 in the actual sheet material 1 is reflected on the orientation distribution of the fiber bundle models 5M in the sheet model 1M, it is possible to generate the sheet model 1M with higher accuracy.

(6) The plurality of fiber bundle models 5M are stacked to be arranged in the sheet model 1M (FIG. 14). When the stacking state of the fiber bundles 5 in the actual sheet material 1 is reflected on the arrangement of the fiber bundle models 5M in the sheet model 1M, it is possible to generate the sheet model 1M with higher accuracy.

(7) The fiber bundle model generation unit 14 generates the fiber bundle model 5M before the analysis of behavior of the fiber model 4M by the behavior analysis unit 16, and generates the virtual fiber bundle model 5Mpst after the analysis (FIG. 19A). The virtual fiber bundle model 5Mpst is generated in addition to the fiber bundle model 5M. Since the virtual fiber bundle model 5Mpst is additionally generated after the behavior analysis, the evaluation accuracy of the product model 2M can be improved without increasing the arithmetic load at the time of behavior analysis.

(8) The fiber model generation unit 15 generates the fiber model 4M before the analysis of behavior of the fiber model 4M by the behavior analysis unit 16; and generates the virtual fiber model 4Mpst after the analysis (FIG. 19A, FIG. 19B). The virtual fiber model 4Mpst is generated in addition to the fiber model 4M. Since the virtual fiber model 4Mpst is additionally generated after the behavior analysis, the evaluation accuracy of the product model 2M can be improved without increasing the arithmetic load at the time of behavior analysis.

The above embodiment may be modified into various forms. In the following, modified examples will be described. In the above embodiment, the behavior of the fiber 4 at the time of molding the sheet material 1 by pressurization is analyzed. However, a resin behavior analysis apparatus that analyzes behavior of a fiber when molding a sheet material is not limited thereto. The resin behavior analysis apparatus may analyze the behavior of the resin in a molding step other than the pressure molding, as well as press molding in which the sheet material is deformed or compression molding in which the sheet material flows.

In the embodiment described above, the fiber bundle model generation unit 14 generates the fiber bundle model 5M until the average value Dn of the thicknesses of the fiber bundle models 5M arranged in the sheet model 1M reaches the preset thickness D1 of the sheet model 1M. However, a fiber bundle model generation unit that generates a fiber bundle model in a sheet model is not limited thereto. The fiber bundle model may be generated until a preset number of bundles is reached.

Although, in the above, the present invention has been described as the resin behavior analysis apparatus 10, the present invention can be used as a resin behavior analysis method configured to analyze behavior of the fiber 4 when molding the sheet material 1 of the fiber reinforced resin including the fiber bundle 5 which is an assembly of a plurality of fibers 4, by a computer. Specifically, the resin behavior analysis method includes: generating the sheet model 1M which is a model of the sheet material 1 (step S2 in FIG. 22); generating the fiber bundle model 5M which is a model of the fiber bundle 5 in the sheet model 1M generated (step S3); generating the fiber model 4M which is a model of the fiber 4 in the fiber bundle model 5M generated (step S5); and analyzing behavior of the fiber model 4M generated, based on the condition for molding the sheet material 1 (step S6), by the computer.

The present invention can also be used as a resin behavior analysis program configured to cause a computer analyze behavior of the fiber 4 when molding the sheet material 1 of the fiber reinforced resin including the fiber bundle 5 which is an assembly of a plurality of fibers 4. Specifically, in the resin behavior analysis program, the computer is caused to execute: the sheet model generation step S2 to generate the sheet model 1M which is a model of the sheet material 1; the fiber bundle model generation step S3 to generate the fiber bundle model 5M which is a model of the fiber bundle 5 in the sheet model 1M generated in the sheet model generation step S2; the fiber model generation step S5 to generate the fiber model 4M which is a model of the fiber 4 in the fiber bundle model 5M generated in the fiber bundle model generation step S3; and the behavior analysis step S6 to analyze behavior of the fiber model 4M generated in the fiber model generation step S5, based on the condition for molding the sheet material 1 (FIG. 22).

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1 sheet material, 2 product (prototype product), 3 mold, 4 fiber, 5 fiber bundle, 10 resin behavior analysis apparatus (apparatus), 11 CPU, 12 memory, 13 sheet model generation unit, 14 fiber bundle model generation unit, fiber model generation unit, 16 behavior analysis unit, 17 evaluation value calculation unit, 1M sheet model, 2M product model, 3M mold model, 4M fiber model, 5M fiber bundle model.

1. A resin behavior analysis apparatus configured to analyze behavior of a fiber when molding a sheet material of a fiber reinforced resin including a fiber bundle which is an assembly of a plurality of fibers, comprising:
a CPU and a memory connected to the CPU, wherein
the CPU is configured to perform:
generating a sheet model which is a model of the sheet material;
generating a fiber bundle model which is a model of the fiber bundle in the sheet model generated;
generating a fiber model which is a model of the fiber in the fiber bundle model generated; and
analyzing behavior of the fiber model generated, based on a condition for molding the sheet material.

2. The resin behavior analysis apparatus according to claim 1, wherein
the fiber bundle model is a three-dimensional model surrounded by a plurality of surfaces including a plane or a curved surface, wherein
the CPU is configured to perform:
generating the fiber bundle model so as to extend in a columnar shape along a fiber direction in which the plurality of fibers extends.

3. The resin behavior analysis apparatus according to claim 2, wherein
the fiber bundle model has a square columnar shape extending along the fiber direction in which the plurality of fibers extends, wherein
the CPU is configured to perform:
generating at least four of the fiber model on sides of the fiber bundle model.

4. The resin behavior analysis apparatus according to claim 2, wherein
the fiber bundle model has a circular columnar shape extending along the fiber direction in which the plurality of the fiber extend, wherein
the CPU is configured to perform:
generating at least four fiber models on a side surface of the fiber bundle model.

5. The resin behavior analysis apparatus according to claim 1, wherein
the sheet model is configured by including a plurality of fiber bundle models extending in different directions from each other.

6. The resin behavior analysis apparatus according to claim 1, wherein
a plurality of fiber bundle models is stacked to be arranged in the sheet model.

7. The resin behavior analysis apparatus according to claim 1, wherein
the CPU is configured to perform:
generating a first fiber bundle model before the analysis of behavior of the fiber model; and
generating a second fiber bundle model after the analysis, wherein
the second fiber bundle model is generated in addition to the first fiber bundle model.

8. The resin behavior analysis apparatus according to claim 1, wherein
the CPU is configured to perform:
generating a first fiber model before the analysis of behavior of the fiber model; and
generating a second fiber model after the analysis, wherein
the second fiber model is generated in addition to the first fiber model.

9. The resin behavior analysis apparatus according to claim 1, wherein
the CPU is further configured to perform:
calculating an evaluation value for evaluating a molded product obtained by molding the sheet material based on a result of the analysis of behavior of the fiber model.

10. A resin behavior analysis apparatus configured to analyze behavior of a fiber included in a sheet material of a fiber reinforced resin when molding the sheet material, comprising:
a CPU and a memory connected to the CPU, wherein
the CPU is configured to perform:
generating a sheet model which is a model of the sheet material;
generating a fiber model which is a model of a plurality of fibers so as to extend on a side surface of a three-dimensional model having a columnar shape surrounded by a plurality of surfaces including a plane or a curved surface in the sheet model generated; and
analyzing behavior of the fiber model generated, based on a condition for molding the sheet material.

11. A resin behavior analysis method configured to analyze behavior of a fiber when molding a sheet material of a fiber reinforced resin including a fiber bundle which is an assembly of a plurality of fibers, by a computer, wherein
the computer is configured to execute steps of:
generating a sheet model which is a model of the sheet material;
generating a fiber bundle model which is a model of the fiber bundle in the sheet model generated;
generating a fiber model which is a model of the fiber in the fiber bundle model generated; and
analyzing behavior of the fiber model generated, based on a condition for molding the sheet material.

12. A non-transitory computer-readable recording medium storing a resin behavior analysis program configured to cause a computer analyze behavior of a fiber when molding a sheet material of a fiber reinforced resin including a fiber bundle which is an assembly of a plurality of fibers, wherein
the resin behavior analysis program, when executed by the computer, causes the computer to execute:
a sheet model generation step to generate a sheet model which is a model of the sheet material;
a fiber bundle model generation step to generate a fiber bundle model which is a model of the fiber bundle in the sheet model generated in the sheet model generation step;
a fiber model generation step to generate a fiber model which is a model of the fiber in the fiber bundle model generated in the fiber bundle model generation step; and
a behavior analysis step to analyze behavior of the fiber model generated in the fiber model generation step based on a condition for molding the sheet material.
